(19) United States
(12) Patent Application Publication
(10) Pub. No.: US 2021/0053720 A1
(43) Pub. Date: Feb. 25, 2021

(54) BIODEGRADABLE CONTAINERS AND BLANKS

(71) Applicant: Roland William Page, Dereham (GB)

(72) Inventor: Roland William Page, Dereham (GB)

(21) Appl. No.: 16/547,460

(22) Filed: Aug. 21, 2019

(51) Int. Cl. B65D 5/56; B65D 5/18; B65D 5/42; B65D 65/46

(52) U.S. Cl. CPC B65D 5/56; B65D 65/466; B65D 5/4204; B65D 5/18

(57) ABSTRACT

A blank for a container for a food product, the blank comprising a substantially rectangular base having four edges, and four side walls extending from each edge of said base; and a lid which is joined to one said side wall by a hinged fold to dose the container in use; wherein each side wall has a top edge and a bottom edge which is joined to the base by a hinged fold; and wherein at least one said side wall is trapezoidal.

### FIELD OF THE INVENTION

The invention relates generally to containers for food and blanks for a container, and more specifically relates to biodegradable and partially biodegradable containers for food and their blanks.

### BACKGROUND TO THE INVENTION

The closest prior art known to the applicant are containers for food products such as raw meats, part-cooked meats or cooked meats, which must be packaged hygienically, safely and in such a way that is sufficiently robust to contain the foodstuff and any of its juices. Containers for storing meats in the refrigerated and frozen sections of supermarkets are particularly relevant.

The current invention seeks to address at least some of the following drawbacks which existing containers suffer from:
The different materials forming containers and their blanks is typically only recyclable in part. For example, many containers are comprised of laminates of plastics, cardboard, and/or plastic films. Therefore, if the container is to be properly recycled after use, each of these materials must be separated by a consumer so that non-recyclable materials can be thrown away and those materials which are recyclable can be done so in the appropriate and proper manner. Different materials disposed of together often present a problem for recycling, even if all materials are recyclable. Many consumers do not go to the effort of doing this and so many containers do not get recycled at all.
Containers and their blanks sometimes comprise a window made of a plastics material, such as a polymer film, so that a customer can view the contents before purchase. These polymer films are often difficult to separate from the rest of the container, meaning that the container is either not recycled at all or is not recycled appropriately.
In order to properly protect the cardboard or other materials capable of absorbing liquids, if they were to be used, they need to be strengthened structurally and hygienically so as not to be compromised. Even where recyclable materials are used, they are often laminated with a polymer which is extremely difficult, if not impossible, to separate from the other materials after use.

There is also a general need to provide containers which are more widely and efficiently recyclable and which are not easily soiled when they contain foods which are themselves or which have fluids susceptible to seeping into the material of a container and potentially onto other surfaces such as a fridge shelf. This is particularly important where a container is placed on the shelf of a fridge or similar and where, therefore, other foods which are not later cooked might encounter potentially harmful bacteria. Thus, there is also a need to improve the capabilities of containers to remain hygienic when filled with those foods.

There is also a general need to provide a blank for a container which is more easily processed and assembled into a container or a partially assembled container. For example, the grasping of a blank from a stack of blanks by an assembling apparatus, to form into a container ready to carry a food item, is typically rapid to allow large volumes of blanks to be processed within a given period of time. The configuration of a blank may affect how straightforwardly the blank is grasped by an assembling apparatus, and thus how rapidly a stack of blanks may be processed and assembled into containers or partially assembled containers.

It is thus an aim of the present invention to provide improved containers and blanks for containers.

### SUMMARY OF THE INVENTION

In a first broad independent aspect, the invention provides a container for a food product, such as raw meat, the container comprising a base and a number of side walls; and a lid connected to the side walls to dose the container in use; wherein the container further comprises a liquid-impermeable membrane, the membrane extending at least partially across an inner surface of the base, the lid and at least one side wall of the container in order that, in use, the membrane substantially surrounds a contained food product and separates the food product from the surfaces to which it is adjacent.

The container is particularly advantageous because it facilitates the provision of an improved biodegradable one-use container for food products such as raw meats, partially cooked meats and cooked meats which might otherwise require container made of non-recyclable materials or would soil containers comprising recyclable materials. In particular, the provision of a liquid-impermeable membrane which shields the rest of the container from the food product allows the rest of the food product to be comprised of a recyclable or biodegradable material such as carton board. More specifically, the liquid-impermeable membrane prevents any juices emanating from the contained food product from seeping into the absorbent materials.

This configuration allows the container to be formed of more recyclable or biodegradable materials even if the liquid-impermeable membrane isn't necessarily recyclable or biodegradable itself.

In a subsidiary aspect, the membrane is provided only on the surface of the lid. Preferably, the membrane is secured to the lid about the perimeter of a window.

In a subsidiary aspect, the membrane comprises a sheet which is distinct from the surfaces to which it is adjacent. This configuration is particularly advantageous because the membrane 16 can be straightforwardly separated from the rest of the container after use so that the container can be more effectively recycled. This is particularly advantageous over existing containers which are comprised of materials which are laminated with a plastics material and which, therefore, are very difficult to separate and recycle appropriately.

In a subsidiary aspect, the membrane is comprised of one or more recyclable materials. Providing a liquid-impermeable membrane comprised of one or more recyclable materials further improves the environmental benefits of the container, because most if not all of the container can be recycled after use (and cleaned if needed).

In a subsidiary aspect, the membrane is comprised of one or more biodegradable materials. This configuration is particularly advantageous because not only does the membrane allow the other components of the container to be made from recyclable or biodegradable materials, but the membrane itself can be more straightforwardly decomposed after use, with food waste for example.

In a subsidiary aspect, the membrane is comprised of a plant derived material. Plant derived material will straightforwardly and effectively decompose after use so that the whole container can be more straightforwardly recycled.

In a further subsidiary aspect, the membrane is comprised of cellulose based material. Cellulose provides a translucent film which prevents food product juices from reaching the rest of the container so as not to soil it. The translucency of the cellulose allows the container to be printed without being obscured by the membrane, and also allows for windows in the container to be provided with a recyclable material.

In an even further subsidiary aspect, the membrane consists entirely of cellulose. Providing a membrane consisting entirely of cellulose further improves the recyclability of the container.

In a subsidiary aspect, the lid comprises an aperture and the membrane extends across the aperture so as to form a window. This configuration is particularly advantageous because it removes the need for a non-recyclable material to be used for a window. Therefore, a potential customer can view the contents of the container without the environmental impact of the container being worsened.

In a subsidiary aspect, the base has four edges and the container comprises four side walls, one side wall joined to each edge of the base; each side wall comprising two opposing short sides and two opposing long sides; wherein each side wall is joined to a respective edge of the base at a long side; and wherein the lid is joined to a side wall at a long edge opposite to the long edge joined to the base; and wherein the membrane extends across an inner surface of the base, the side wall located between the base and the lid and at least part of the lid.

This configuration is particularly advantageous because it can be formed from a blank which is formed as a continuous sheet and the membrane can be straightforwardly joined to the container. This minimises the number of components required for the container, and the formed container effectively seals a food product and can be more straightforwardly recycled after use.

In a further subsidiary aspect, the membrane extends at least partially across an inner surface of the side wall at the edge of the base opposite to the side wall located between the base and the lid. This configuration is particularly advantageous because a single sheet membrane can be joined to the rest of the container to separate a food product from the container in use.

In a subsidiary aspect, the membrane extends across the entire width of the lid. Extending the membrane across the entire width of the lid minimises the risk that the container becomes soiled by the food product in use.

In a subsidiary aspect, the lid is attached to a side wall by an adhesive. An adhesive effectively closes the container to protect and hygienically store a food product.

In a subsidiary aspect, the base, each side wall and the lid are formed as a continuous sheet. This configuration is particularly advantageous because the manufacturing process for forming a container is more straightforward. More specifically, fewer instances of adhesive or other means of sealing are required when the container is comprised of a single continuous sheet of material.

In a subsidiary aspect, the membrane is joined to the base by an adhesive. Joining the membrane to the base by an adhesive minimises the risk that the food product or juices from the food product come into contact with the base, side walls or lid of the container.

In a subsidiary aspect, at least one strip of adhesive extends across the width of the lid, the base and the at least one side wall to which the membrane is attached. Providing adhesive in the form of a strip which extends across the width of the inner surfaces to which the membrane is attached, minimises the number of applications of adhesive required to securely fix the membrane to the rest of the container. A strip which runs across the width of those components also minimises the risk that the membrane will become unfixed during use, compared to fixing the membrane to fewer components or applying the adhesive as a plurality of adhesive dots, for instance.

In a subsidiary aspect, the base, the side walls and the lid are comprised of one or more recyclable materials. This configuration is particularly advantageous because a greater proportion of the container is formed of recyclable material.

In a further aspect, the invention provides a blank for a container for a food product in accordance with any of the preceding aspects.

The blank is particularly advantageous because it facilitates the provision of an improved biodegradable container for food products which might otherwise require a container made of non-recyclable materials.

In a subsidiary aspect, the base, the side walls and the lid are formed of a continuous sheet. Providing a base, side walls and lid formed of a continuous sheet further minimises the risk, compared to a container comprising several sheets, that a food product spreads potentially harmful bacterium.

In a subsidiary aspect, adjacent side walls are joined together by a web. Providing webs between adjacent side walls even further minimises the risk that potentially harmful bacteria are spread. This configuration also improves the structural integrity of the container.

The present inventive concept is also directed to a blank for a container for a food product, the blank comprising a substantially rectangular base having four edges, and four substantially rectangular side walls extending from each edge of said base; and a lid which is joined to one said side wall by a hinged fold to close the container in use; wherein each side wall has a top edge and a bottom edge which is joined to the base by a hinged fold; and wherein at least one said side wall is trapezoidal.

Thus, a Hank may be more straightforwardly grasped to form into a container because a trapezoidal side wall naturally raises in relation to the plane of the base.

This embodiment also envisages blanks with or without a window and blanks with or without a lining of the kind described in other embodiments.

The join between the base and the at least one side wall may be shorter in length than the top edge of the same side wall.

The difference in length of the top and bottom edges of a side wall cause that side wall to raise slightly relative to the rest of the blank. The raising of the side wall provides a portion for a handler or assembling apparatus to grasp the blank to move it or assemble it into a container. A stack of several blanks may be processed more rapidly because each individual blank is more easily grasped for processing before the next blank is processed.

The trapezoidal side wall may be only just trapezoidal in that the different in length between the top and bottom edges is less than a few millimetres and preferably around 1 millimetre.

The blank may have two long side walls and two short side walls joined to the substantially rectangular base. The lid may be joined to a long side wall, and the at least one trapezoidal side wall is a short side wall adjacent to the wall joined to the lid.

Providing a trapezoidal side wall adjacent to the wall joined to the lid allows the blank to be grasped from one end for processing.

Each of the two short side walls may be a trapezoidal side wall whereby the join between the base and each short side wall is shorter in length than the top edge of the respective side walls. Providing the two short side walls as trapezoidal side walls allows the blank to be more straightforwardly grasped from either end. Where both short side walls are trapezoidal walls this also causes the long sides to raise up and the blank may thus be grasped at a long side for processing. A stack of blanks may thus be processed more rapidly.

Each side wall may be a trapezoidal side wall, whereby the join between the base and each side wall is shorter in length than the top edge of the respective side walls. Providing each side wall as a trapezoidal wall allows the blank to be grasped at any side wall for processing and assembly into a container. This arrangement avoids the need to position the blank at a particular orientation for processing because any side wall may be grasped.

Adjacent side walls may be joined to one another by a web formed by two substantially triangular portions, wherein the triangular portions of the web are collapsible onto one another towards the base when the blank is assembled into a container. The webs formed between adjacent side walls improve the hygiene of an assembled container because there are no penetrable gaps between side walls when a container is assembled. The webs also provide a location for an adhesive to secure parts of the blank to one another as the blank is formed into a fully or partially assembled container. For example, an adhesive may be applied to one or more of the triangular portions of a web to secure the web to a side wall.

Each triangular portion of a web may comprise a free edge, and the angle between two free edges of adjacent triangular portions of a web may be an obtuse angle. An obtuse angle between the free edges of adjacent triangular portions causes a web to rise in relation to a plane of the base. This augments the raising of a side wall so that the blank may be more straightforwardly grasped by an assembling apparatus. With this arrangement, the webs are slanted away from the lid when a container is assembled from the blank. This arrangement ensures that the webs do not obstruct the lid when it is folded to dose the container.

The angle defined by the free edge of a web may be slightly greater than 90 degrees.

The top edge of each side wall may comprise a flange which is connectable to the lid when the blank is assembled to form a container.

Each flange may be arranged so that the flanges of each side wall together form a substantially continuous rim when the blank is assembled to form a container. A substantially continuous rim formed by the flange of each side wall improves the hygiene of an assembled container because the lid may be connected to each side wall around the perimeter of the lid. The lid is thus more rigidly fixed to the side walls of the container once assembled.

The container may be formed of a substantially recyclable material. The container may be formed of a substantially biodegradable material.

The present inventive concept is also directed to a container for a food product formed by a blank according to the above aspects.

### BRIEF DESCRIPTION OF THE DRAWINGS

FIG. 1 shows a plan view of a blank.

FIG. 2 shows a perspective view of a partly assembled container.

FIG. 3 shows a perspective view of a container.

FIG. 4 shows a plan view of a partly assembled container.

FIG. 5 shows a plan view of a blank.

### DETAILED DESCRIPTION OF THE EMBODIMENTS

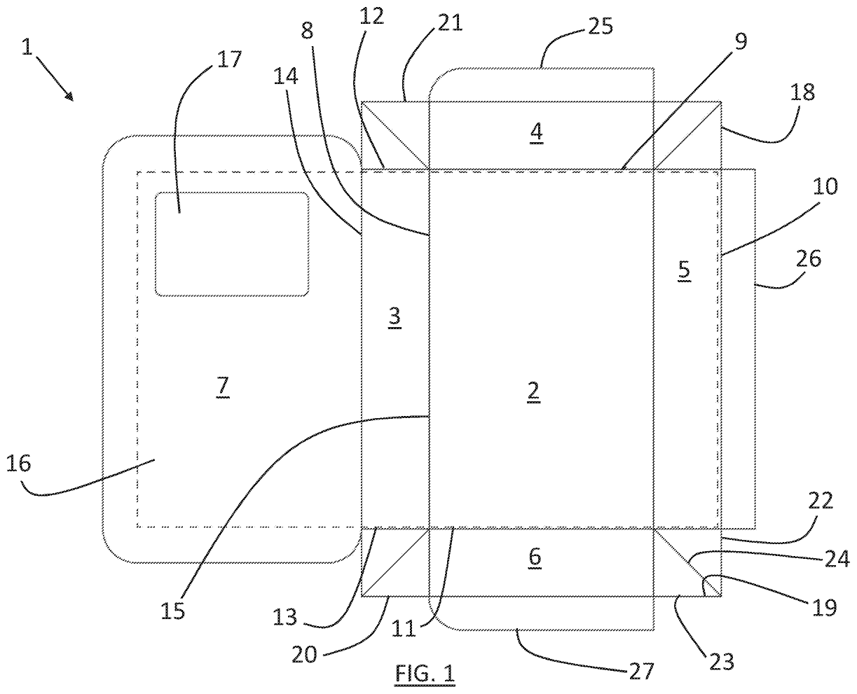

FIG. 1 shows a blank for a container generally referenced 1 with a base 2, a number of side walls, 3, 4, 5, 6 and a lid 7. The base 2 is planar and comprises four edges 8, 9, 10, 11. In this first embodiment, two edges of the base 8, 10 are long edges and the other two edges 9, 11 are short edges. In alternative embodiments, the base may have a different configuration, for example four edges of equal length. Two long side walls 3, 5 and two short side walls 4, 6 are joined to the respective long and short edges of the base 2. The side walls are rectangular and comprise two short sides, such as 12, 13 and two long sides, such as 14, 15. When the Hank is assembled, the four side walls are folded upwards and adjacent side walls are joined to form a tray. The lid 7 is joined at one of the side walls 3 at a long side 14 opposite another long side 15 which is attached to the base 2. In this embodiment, the blank for the container 1 is formed of a continuous sheet and is preferably comprised of a recyclable and/or biodegradable material such as carton board.

In alternative embodiments, the container 1 may be of any shape suitable to contain a food product, e.g. a traditional prism-shaped container typically used for containing sandwiches. Other materials known to the skilled person may also be used.

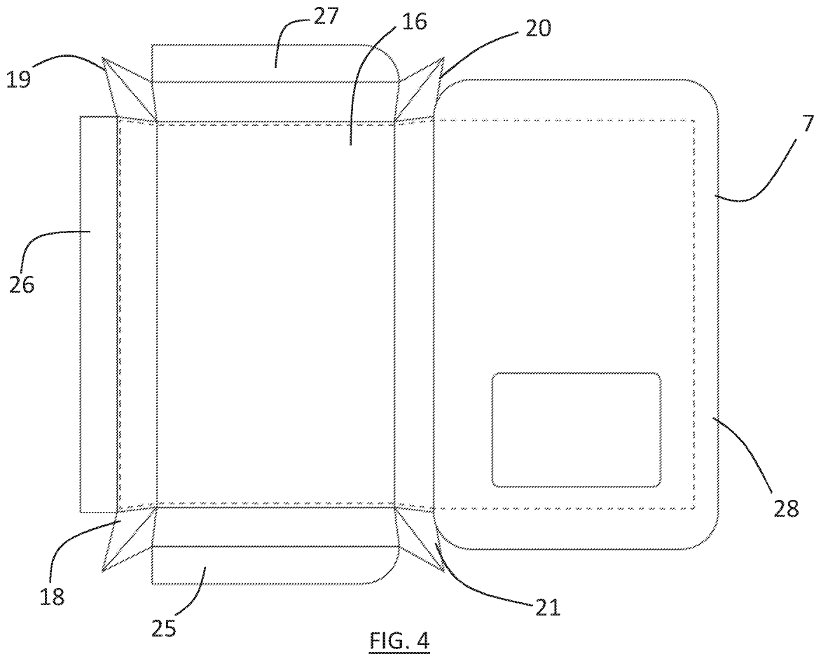

The container 1 further comprises a liquid-impermeable membrane 16, demarcated by the dashed line, which extends at least across an inner surface of the base 2, the side wall 3 located between the base and the lid, and at least part of the lid 7. When the container 1 is assembled, the liquid-impermeable membrane 16 therefore substantially surrounds a food product and separates the food product from the rest of the container 1, i.e. from the carton board of the base, lid and side wall to which the membrane 16 is attached. This way, the rest of the container can be formed of recyclable or biodegradable materials, such as carton board, without a risk that the food product will soil or leak out of the container 1. This is particularly pertinent where the container contains a food product liable to carry potentially harmful bacteria. In an alternative embodiment, as shown in FIG. 4, the membrane 16 extends across an inner surface of the entire container 1, or additional parts of the container 1 (also demarcated by the extended dashed line in FIG. 1) so as to increase the separation between the contained food product and the rest of the container 1.

The configuration of the container 1, with the membrane 16 extending across an inner surface of the lid, the base and at least one side wall, is particularly advantageous over containers formed of board laminated with a plastics material because the membrane can be separated from the other components of the container 1 after use for more straightforward recycling. Where the membrane 16 is comprised of a recyclable and/or biodegradable material, disposal of the container 1 is made even more straightforward. By contrast, containers 1 comprising board laminated with a plastics material cannot be separated and recycled easily because the laminated board is a single piece. Instead, the membrane 16 of the container 1 is a distinct piece which effectively covers the other components of the container, shielding them from potentially damaging or harmful products, and which can be straightforwardly separated after use.

The membrane 16 is a single sheet in the embodiment of FIG. 1, to minimise the risk that fluids exit the container 1, but the membrane 16 may be comprised of a plurality of sheets.

In a preferred embodiment, the membrane 16 itself is comprised of one or more recyclable or biodegradable materials so that the entire container 1 or most of it can be recycled after use. In the embodiment of FIG. 1, the membrane 16 is comprised of a plant derived material, preferably cellulose based, but could be comprised of any recyclable and/or biodegradable material. In another alternative embodiment, the membrane 16 may be comprised of a non-recyclable material, such as a polymer, but would still enable the rest of the container 1 to be formed of recyclable or biodegradable materials, particularly because the membrane 16 is distinct from the base, lid and side walls and can thus be separated by a consumer after use.

In a preferred embodiment, the membrane 16 entirely consists of cellulose. In this and other preferred embodiments, the membrane comprises transparent or translucent material so that the membrane 16 can be utilised as a window. Therefore, no other polymers or similar non-recyclable materials need to be used for windows. Thus, in a further preferred embodiment, the lid 7 comprises an aperture 17 and the membrane 16 extends across the aperture 17 to form a window. The contents of the container 1 may therefore be viewed without the need for non-recyclable materials. Even where the membrane 16 comprises a non-recyclable material, it may extend across the aperture 17 of the lid 7 in this way, and the membrane (including the window) can be straightforwardly separated from the rest of the container 1 after use for recycling.

Adjacent side walls are joined together by a web 18, such that web 21 is located between side walls 3 and 4; web 18 is located between side walls 4 and 5; web 19 is located between side walls 5 and 6; and web 20 is located between side walls 6 and 3. In the embodiment of FIG. 1, the webs are each formed by a succession of two triangular sections, such as 22 and 23, which are joined by a hinged fold 24. This configuration provides the container 1 with rigid corners and improved structural integrity such that the container remains useable as an open container when the lid 7 has been partially or fully detached. The two triangular sections of each web are disposed inwardly to minimise the risk of contamination into the container 1, or equally from the food product inside the container to the outside environment.

As further shown by FIG. 1, the container 1 comprises lips 25, 26, 27 to facilitate attachment of the lid 7 to the side walls to dose the container 1. Lips 25, 26, 27 are located along side of side walls 4, 5 and 6, respectively, and the lid 7 is joined to side wall 3. In use, when the side walls are in their assembled configuration, the lips (or flanges) are disposed outwardly so that the inner surface of the lid 7 can come into contact with the lips and be sealed to the lips. The inner surface of the lid 7 at the region which contacts the lips may be covered by the membrane 16. An adhesive (not shown) may be used to seal the lid 7 to the lips or, alternatively, the container may be heat sealed when a food product is contained therein. In the embodiment of FIGS. 1, 2 and 3, the lid 7 overhangs the side walls and extends beyond the boundary of the side walls to allow the lid 7 to be easily grasped by a user. The overhang also facilitates an intuitive method of opening the container 1, by grasping the lid adjacent side wall 5 and pulling the lid 7 away from the base 2.

The join between the lips and the side walls may be perforated or otherwise weakened to facilitate tearing to open the container 1. Alternatively, the lid 7 may comprise a section with a weakened perimeter so that only the section of the lid 7 is peeled away to access the contents of the container 1. Other parts of the container may also be similarly weakened to facilitate entry.

In an alternative embodiment, not shown in the Figures, the membrane 16 extends across substantially the entire width of the lid 7 so as to improve the structural integrity of the membrane 16 and to further minimise the risk that any foodstuff exits the container before it is opened.

In a preferred embodiment, the membrane is attached to the inner surfaces of the lid 7, the base 2, and the at least one side wall 3 by an adhesive. As shown in FIG. 4, the adhesive is preferably arranged as a strip which extends across the width of each surface to which the membrane 16 is attached. In alternative embodiments, a plurality of adhesive dots or similar are used to fix the membrane 16 to the container 1.

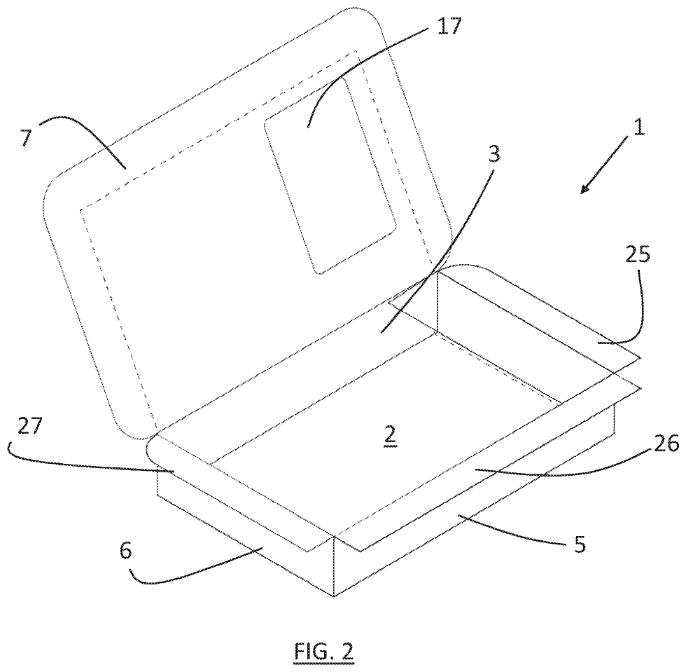

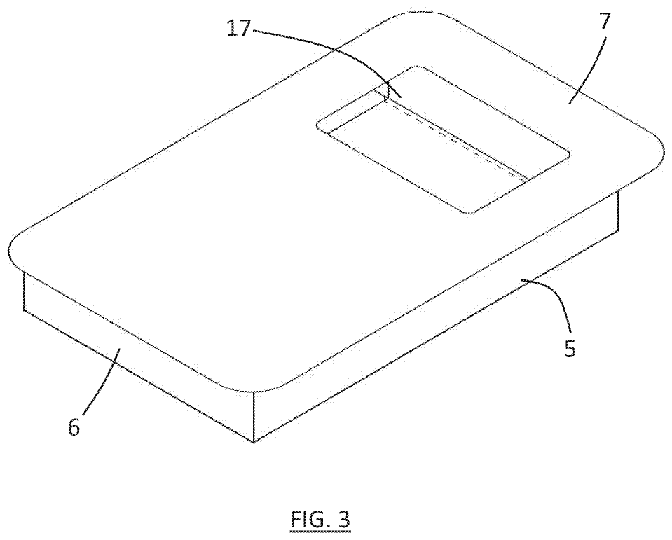

FIG. 2 shows a partially assembled container 1 which is formed from the blank of FIG. 1, wherein the side walls 3, 4, 5, 6 are substantially perpendicular to the base 2 and the lips 25, 26, 27 are disposed outwardly ready to be fixed to the lid 7. A food product is placed in the cavity formed by the base 2 and side walls and the lid 7 is then fixed to the lips 25, 26, 27 to enclose the food product. The membrane 16, which extends at least partially across the inner surface of at least the lid 7, the base 2 and the side wall 3 substantially surrounds the food product once the container 1 is dosed, as shown in FIG. 3. To surround the food product to a greater extent, the membrane 16 may also extend at least partially across the inner surface of side wall 5 and/or side walls 4 and 6. In a preferred embodiment, the membrane 16 extends around entire inner surface of the container 1 to maximise the sealing of the food product inside the container 1.

Three separate lips or flanges 25, 26, 27 are illustrated in FIG. 2, but as greater or lesser number of lips may be provided with the same or a similar effect. For example, a single lip may extend around the perimeter of side walls 4, 5 and 6. The embodiment of the Figures is preferred because it is believed that this configuration provides an optimum seal when the container 1 is dosed.

Referring to FIG. 3, when the container 1 is dosed, the membrane 16 (not shown) folds to surround the contained food product. Therefore, it is preferred that the membrane 16 is comprised of materials which allow the membrane to be sufficiently flexible to allow the container to open and close freely and effectively surround the food product. If more rigid materials are chosen, it is preferable to provide the membrane 16 as a plurality of pieces which are each fixed to the inner surface of at least one of the base 2, the lid 7 and the side walls.

The container 1 may be provided as a blank, as shown in FIG. 1 or as partly assembled or assembled containers as shown in FIGS. 2 and 3, respectively.

FIG. 4 shows a blank of the container 1 wherein the membrane 16, formed as a continuous sheet, covers the entire surface of side walls 3 and 5 and base 2 and extends partially across the inner surface of the lid 7. The lid 7 comprises a border 28 which is not covered by the membrane 16 so that the lid 7 can be fixed to the lips 25, 26, 27 when the container 1 is assembled. Two strips of adhesive fix the membrane 16 to the container 1. The strips of adhesive run across the width of the lid 7 (except the border 28), side wall 3, the base 2 and side wall 5. In another embodiment, the membrane 16 may extend to cover side walls 4 and 6 as well, or additional pieces of membrane 16, which are not part of the continuous sheet, are fixed to side walls 4 and 6. The webs 18, 19, 20, 21 may also be covered with the membrane 16, although this is not the case in the preferred embodiment of the Figures.

The container 1 of this preferred embodiment comprises a base and four side walls which are joined to four edges of the substantially rectangular base. The lid 7 is also substantially rectangular. Other shapes and dimensions of containers for food products are also envisaged. For example, a typical sandwich-style, triangular prism-shaped container may be provided which comprises a rectangular base and three side walls. One of the side walls being rectangular and the other two side walls being substantially triangular. Typically, a rectangular lid is also provided which is joined to the base or one of the side walls by a hinged fold, and which is fixed to the other of the base and/or side walls in use to contain a food product. In this additional embodiment, the inner surfaces of the base, the lid and any number of the side walls may be covered by the membrane to more effectively seal the food product and any associated fluids inside the container. Other known shapes of containers may also be similarly utilised.

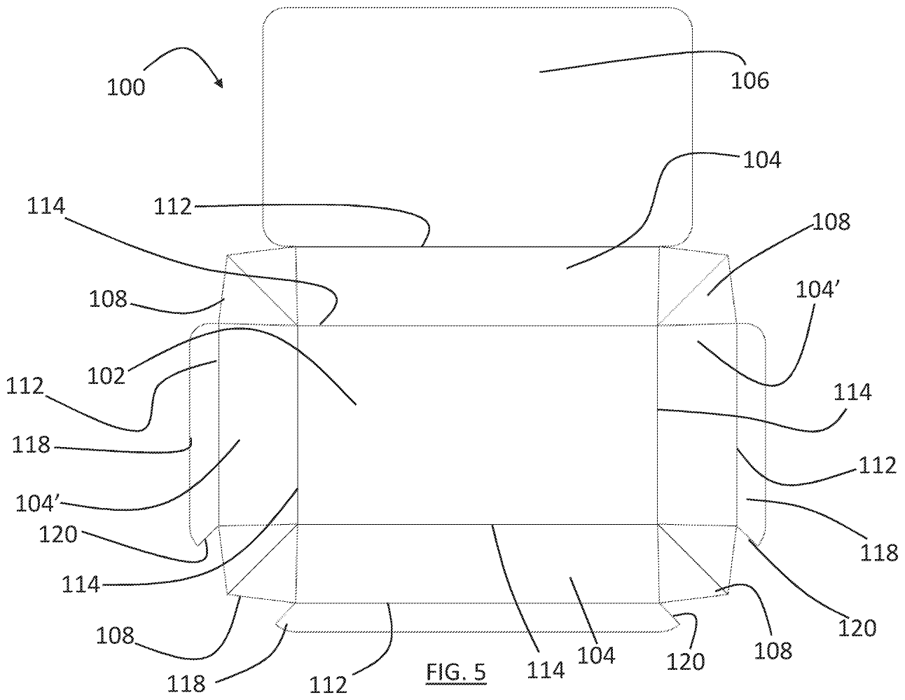

FIG. 5 shows a blank 100 for a container. The blank comprises a rectangular base 102 and four rectangular side walls 104. A side wall 104 extends from each side of the base 102. Two edges of the base 102 and the side walls 104 extending from those edges are relatively long, and the other two edges of the base 102 and associates side walls 104′ are shorter. Each of the side walls 104 is joined to the base 102 by a hinged fold.

A lid 106 extends from one of the longer side walls 104 and is joined to the side wall 104 by a hinged fold. In use, when the blank is assembled into a container, the lid 106 is brought into contact with each of the side walls 104 to dose the container. The lid is formed by a continuous unitary portion and does not comprise a window. Each one of the corners of the lid is rounded.

Adjacent side walls 104 are joined to one another by a web 108. Each web 108 is formed by a succession of two triangular portions. The triangular portions are joined to one another by a hinged fold along a long edge of each portion. The web 108 is arranged so that the triangular portions are collapsible onto one another when the Hank 100 is assembled into a container, and the triangular portions are disposed inwardly towards the base 102.

Each of the side walls has a top edge 112 and a bottom edge 114. The bottom edge 114 of each side wall is joined the base 102 by a hinged fold. The two short side walls 104′ are trapezoidal, in that the join between the base and the side wall is shorter in length than the top edge 112 of the same side wall 104′. The width of the side walls 104′ therefore narrows towards the base 102. The side walls 104′ are only just trapezoidal, in that the difference in length between the top edge 112 and the bottom edge 114 is around 1 millimetre.

Each of the triangular portions of a web 108 has a free edge 116. The angle between free edges 116 of adjacent triangular portions is an obtuse angle. The obtuse angle is slightly greater than 90 degrees.

Each side wall 104 comprises a flange 118 at the top edge 112 of the side wall 104. Each flange 118 is arranged to be connectable to the lid 106. Each flange is also arranged to form a substantially continuous rim around the perimeter of the lid 106 when a container is formed from the blank 100. The flange 118 extending from the top edge 112 of each of the short side walls 104′ are rounded at one end and have a cut away portion 120 at the opposite end. The flange 118 extending from the top edge 112 of the long side wall 104 not connected to the lid 106 comprises a cut away portion 120 at each end of the flange 118. The cut away portions of flanges of adjacent side walls are arranged to cooperate with one another to form a substantially continuous rim around the perimeter of the lid 106.

Referring to FIG. 5, the base 102 may have a length 187 mm and a width of 103 mm. Each side wall has a width of 41 mm. The length of the short side walls 104 differs between the top edge and the bottom edge of the side wall 104. The bottom edge 114 of a short side wall 104′ has a length of 103 mm. The top edge 112 of a short side wall 104′ has a length of 104 mm.

The lid 106 has a width of 124 mm and a length of 223 mm. Each of the flanges has a width of 15 mm. The length of each flange 118 increases outwardly from the side wall to which it is joined.

The blank 100, including the flanges 118, has a length of 324 mm and a width of 299 mm.

1. A container for a food product, such as raw meat, the container comprising a base and a number of side walls; and a lid connected to the side walls to dose the container in use; wherein the container further comprises a liquid-impermeable membrane, the membrane extending at least partially across an inner surface of the base, the lid and at least one side wall of the container in order that, in use, the membrane substantially surrounds a contained food product and separates the food product from the surfaces to which it is adjacent.

2. A container according to claim 1, wherein the membrane comprises a sheet which is distinct from the surfaces to which it is adjacent.

3. A container according to claim 1, wherein the membrane is comprised of at least one recyclable material.

4. A container according to claim 1, wherein the membrane is comprised of at least one biodegradable material.

5. A container according to claim 1, wherein the membrane is comprised of a plant derived material.

6. A container according to claim 1, wherein the membrane is comprised of cellulose based material.

7. A container according to claim 1, wherein the membrane consists entirely of cellulose.

8. A container according to claim 1, wherein the lid comprises an aperture and the membrane extends across the aperture so as to form a window.

9. A container according to claim 1, wherein the base has four edges and the container comprises four side walls, one side wall joined to each edge of the base; each side wall comprising two opposing short sides and two opposing long sides; wherein each side wall is joined to a respective edge of the base at a long side; and wherein the lid is joined to a side wall at a long edge opposite to the long edge joined to the base; and wherein the membrane extends across an inner surface of the base, the side wall located between the base and the lid and at least part of the lid.

10. A container according to claim 9, wherein the membrane extends at least partially across an inner surface of the side wall at the edge of the base opposite to the side wall located between the base and the lid.

11. A container according to claim 1, wherein the membrane extends across the entire width of the lid.

12. A container according to claim 1, wherein the lid is attached to a side wall by an adhesive.

13. A container according to claim 1, wherein the base, a side wall and the lid are formed as a continuous sheet.

14. A container according to claim 1, wherein the membrane is joined to the base by an adhesive.

15. A container according to claim 14, wherein at least one strip of adhesive extends across the width of the lid, the base and the at least one side wall to which the membrane is attached.

16. A container according to claim 1, wherein the base, the side walls and the lid are comprised of at least one recyclable material.

17. A blank for a container for a food product in accordance with claim 1.

18. A blank in accordance with claim 17, wherein the base, the side walls and the lid are formed of a continuous sheet.

19. A Hank in accordance with claim 17, wherein adjacent side walls are joined together by a web.

20. A Hank for a container for a food product, the blank comprising a substantially rectangular base having four edges, and four side walls extending from each edge of said base; and a lid which is joined to one said side wall by a hinged fold to close the container in use; wherein each side wall has a top edge and a bottom edge which is joined to the base by a hinged fold; and wherein at least one said side wall is trapezoidal.

21. A blank according to claim 20, wherein the join between the base and the at least one side wall is shorter in length than the top edge of the same side wall.

22. A blank according to claim 20, wherein the blank has two long side walls and two short side walls joined to the substantially rectangular base; the lid is joined to a long side wall; and the at least one trapezoidal side wall is a short side wall adjacent to the wall joined to the lid.

23. A blank according to claim 20, wherein each of the two short side walls is a trapezoidal side wall whereby the join between the base and each short side wall is shorter in length than the top edge of the respective side walls.

24. A Hank according to claim 20, wherein each side wall is a trapezoidal side wall, whereby the join between the base and each side wall is shorter in length than the top edge of the respective side walls.

25. A Hank according to claim 20, wherein adjacent side walls are joined to one another by a web formed by two substantially triangular portions; wherein the triangular portions of the web are collapsible onto one another towards the base when the blank is assembled into a container.

26. A blank according to claim 25, wherein each triangular portion of a web comprises a free edge; and the angle between two free edges of adjacent triangular portions of a web is an obtuse angle.

27. A blank according to claim 26, wherein the angle between the free edges of adjacent triangular portions a web is slightly greater than 90 degrees.

28. A blank according to claim 20, wherein the top edge of each side wall comprises a flange which is connectable to the lid when the blank is assembled to form a container.

29. A blank according to claim 28, wherein each flange is arranged so that the flanges of each side wall together form a substantially continuous rim when the blank is assembled to form a container.

30. A container for a food product formed by a blank according to claim 20.
